(19) United States
(12) Patent Application Publication
(10) Pub. No.: US 2013/0342660 A1
(43) Pub. Date: Dec. 26, 2013

(54) 3D IMAGE TAKING APPARATUS

(71) Applicant: FUJIFILM Corporation, Tokyo (JP)

(72) Inventor: Yoichi IWASAKI, Saitama-shi (JP)

(73) Assignee: FUJIFILM Corporation, Tokyo (JP)

(21) Appl. No.: 14/013,692

(22) Filed: Aug. 29, 2013

Related U.S. Application Data
(63) Continuation of application No. PCT/JP2011/075737, filed on Nov. 8, 2011.

(30) Foreign Application Priority Data
Mar. 2, 2011 (JP) 2011-045544

(51) Int. Cl. H04N 13/02

(52) U.S. Cl. CPC H04N 13/0239
USPC 348/47

(57) ABSTRACT

A 3D image taking apparatus includes: a monocular photographic lens; a first and second solid-state imaging devices that receive one part and another part of incident light coming from a subject via the photographic lens in parallel; a light splitting member that splits the incident light into the one part and the other part of the incident light using a boundary region that extends perpendicularly to an optical axis, and causes the one part and the other part of the incident light to enter the first and second solid-state imaging devices, respectively; a parallax separation member that prevents a part of the incident light entering the boundary region from entering the first and second solid-state imaging devices; and an image processing unit that generates 3D image data of the subject by performing image processing on respective output signals of the first and second solid-state imaging devices.

### CROSS REFERENCE TO RELATED APPLICATION

This is a continuation of International Application No. PCT/JP2011/075737 filed on Nov. 8, 2011, and claims priority from Japanese Patent Application No. 2011-045544, filed on Mar. 2, 2011, the entire disclosures of which are incorporated herein by reference.

### TECHNICAL FIELD

The present invention relates to a 3D image taking apparatus. More particularly, the invention relates to a monocular 3D image taking apparatus capable of satisfactory left/right separation for a parallax.

### BACKGROUND ART

TV receivers capable of displaying a 3D image have come into wide use, and there are indications that digital cameras capable of taking a 3D image of a subject (3D image taking apparatus) are beginning to spread.

As disclosed in, for example, Patent Literature 1 (see below), conventional 3D image taking apparatus are of a binocular type and are equipped with two shooting lens systems which are disposed on the front side of a camera body and arranged in the horizontal direction. The photographic lens systems located on the left side and the right side (as viewed from the front side) correspond to the right eye and the left eye of a human, respectively. The left and right photographic lens systems are separated by about 6.5 cm which is the average distance between the left eye and the right eye of a human.

Such binocular 3D image taking apparatus can take subject images that are high in the degree of left/right separation for a parallax because a left-eye subject image and a right-eye subject image are taken through the separate photographic lens systems which are spaced from each other by 6.5 cm.

However, because of the use of two expensive photographic lens systems, binocular 3D image taking apparatus have a problem that they are costly.

In view of the above, a monocular 3D image taking apparatus disclosed in Patent Literature 2 (see below) has been proposed. In this 3D image taking apparatus which is equipped with a single photographic lens system, incident light coming from a subject and focused by the photographic lens system is converted into parallel light by causing it to pass through a relay lens.

As shown in FIG. 8, parallel light 1 obtained by the relay lens is separated into left and right light beams by a light splitting mirror 4 which includes of two mirrors 2 and 3 which are in contact with each other and form a right angle. The light reflected from the mirror 2 is again reflected by a mirror 5 and forms an image on an image sensor 6. The light reflected from the mirror 3 is again reflected by a mirror 7 and forms an image on an image sensor 8.

A photographic lens system is disposed on the light incidence side of the relay lens which outputs the parallel light 1. Since the incident light coming from a subject field is left/right-inverted, images corresponding to the left eye and the right eye are formed on the image sensors 6 and 8, respectively.

FIG. 9 is a graph showing incident angle vs. sensitivity characteristics in the left-right direction of the image sensors 6 and 8 shown in FIG. 8. Since the parallel light 1 obtained by the relay lens from the incident light is divided into two parts by the light splitting mirror 4, as shown in FIG. 9, a sensitivity distribution TL with respect to the incident angle of the image sensor 6 which receives the light reflected from the mirror 5 is shifted rightward (as viewed from the camera side). Conversely, a sensitivity distribution TR with respect to the incident angle of the image sensor 8 which receives the light reflected from the mirror 7 is shifted leftward.

A 3D image which enables stereoscopic vision of a subject can be obtained by reproducing, as a left-eye image and a right-eye image, respectively, images taken by the image sensors 6 and 8 whose sensitivity distributions are shifted in the left-right direction. However, if the shifts in the left-right direction which correspond to a parallax are insufficient, a good 3D image cannot be obtained by reproducing a left-eye image and a right-eye image.

### CITATION LIST

### Patent Literature

Patent Literature 1: JP-A-2008-187385

Patent Literature 2: JP-A-2010-81580

### SUMMARY OF INVENTION

### Technical Problem

The above-mentioned binocular stereoscopic cameras can produce a sufficient left-right parallax because they are equipped with the two photographic lens systems which are spaced from each other by 6.5 cm. On the other hand, the example monocular stereoscopic camera shown in FIG. 8 cannot produce a sufficient left-right parallax.

An object of the present invention is to provide a monocular 3D image taking apparatus capable of taking a good 3D image.

### Means for Solving the Problems

### Solution to Problem

A 3D image taking apparatus of the present invention includes: a monocular photographic lens; a first and second solid-state imaging devices that receive one part and another part of incident light coming from a subject via the photographic lens in parallel; a light splitting member that splits the incident light into the one part and the other part of the incident light using a boundary region that extends perpendicularly to an optical axis, and causes the one part and the other part of the incident light to enter the first and second solid-state imaging devices, respectively; a parallax separation member that prevents a part of the incident light entering the boundary region from entering the first and second solid-state imaging devices; and an image processing unit that generates 3D image data of the subject by performing image processing on respective output signals of the first and second solid-state imaging devices.

### Advantageous Effects of Invention

According to the invention, since that part of incident light which would otherwise enter the region including the boundary line for separation for a parallax and having the prescribed width is cut, left/right separation for a parallax can be attained satisfactorily and 3D image data that enable stereoscopic vision can be obtained though the apparatus is of the monocular type.

### BRIEF DESCRIPTION OF DRAWINGS

FIG. 1 is a perspective view showing an appearance of a 3D image taking apparatus according to an embodiment of the present invention.

FIG. 2 is a block diagram showing the functional configuration of the 3D image taking apparatus of FIG. 1.

FIG. 3 illustrates a parallax separation means and a light splitting mirror shown in FIG. 2.

FIG. 4 is a graph illustrating an effect of cutting that part of incident light which would otherwise shine on a light splitting boundary line and its neighborhood.

FIG. 5 is a perspective view of a parallax separation means and a light splitting means used in another embodiment that are integrated together.

FIGS. 6A and 6B illustrate a parallax separation means and a light splitting means used in still another embodiment that are integrated together.

FIG. 7 shows a light splitting mirror used in a further embodiment.

FIG. 8 illustrates a conventional monocular 3D image taking apparatus.

FIG. 9 is a graph showing incident angle vs. sensitivity characteristics in the left-right direction of image sensors 6 and 8 shown in FIG. 8.

### DESCRIPTION OF EMBODIMENTS

Embodiments of the present invention will be hereinafter described with reference to the drawings.

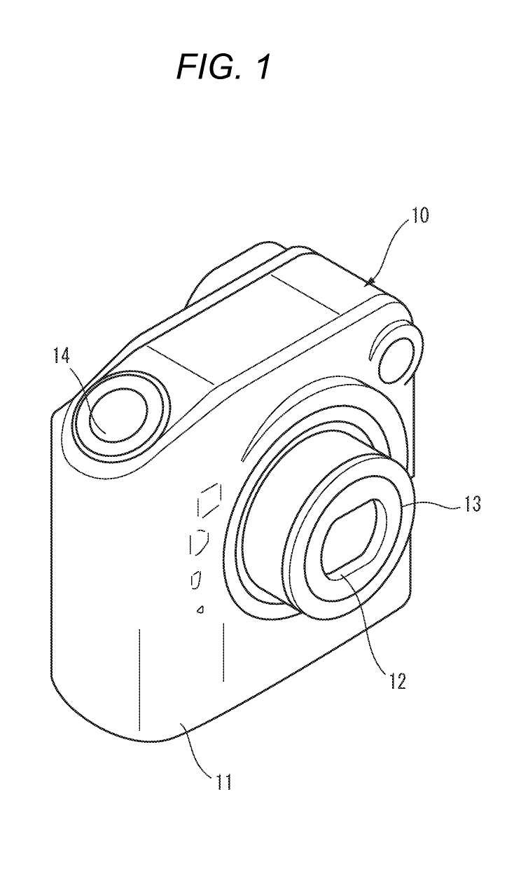

FIG. 1 is a perspective view of a digital camera according to an embodiment of the invention which can take a 3D image. In the digital camera 10, a monocular photographic lens 12 is disposed on the front side of a rectangular body 11. The photographic lens 12 is provided in a lens barrel 13 which can retract into the body 11. The body 11 is provided with a shutter release button 14 at the top-right corner.

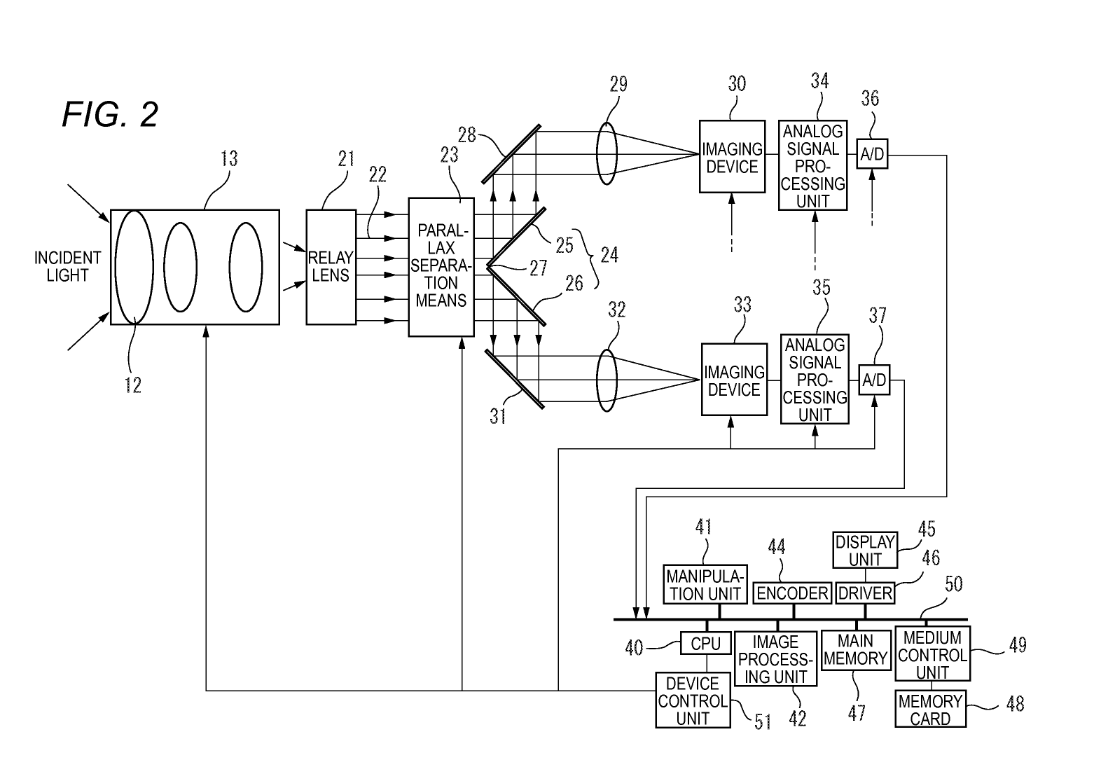

FIG. 2 is a block diagram showing the functional configuration of the digital camera 10 of FIG. 1. The digital camera 10 is equipped with the lens barrel 13 which houses the photographic lens 12. The lens barrel 13 houses a focal point adjustment lens, a telescopic lens, etc. in addition to the photographic lens 12.

A relay lens 21 is disposed behind the lens barrel 13. Incident light as focused by the photographic lens 12 etc. passes through the relay lens 21 and is thereby converted into parallel light 22.

A parallax separation means 23 and a light splitting mirror 24 are disposed on the optical path of the parallel light 22. In this embodiment, the parallax separation means 23 (described later in detail) is a liquid crystal shutter. The light splitting mirror 24 is configured in such a manner that the front edges of two mirrors 25 and 26 are in contact with each other. It is preferable to dispose a stop for controlling the f-number before or after the parallax separation means 23.

The mirror 25 is inclined so that its right-hand edge is located in the rear of its left-hand edge and an angle 45° is formed with the parallel light 22, and the mirror 26 is inclined so that its left-hand edge is located in the rear of its right-hand edge and an angle 45° is formed with the parallel light 22. The mirrors 25 and 26 are joined to each other in such a manner that their front edges are in contact with each other. A joining edge 27 extends perpendicularly to the bottom surface of the body 11 shown in FIG. 1. As a result, the left half of the parallel light 22 is reflected leftward in the horizontal direction by the mirror 26 and its right half is reflected rightward in the horizontal direction by the mirror 25, with the joining edge 27 serving as a boundary line.

A mirror 28 is somewhat spaced from the reflection surface of the mirror 25 so as to be parallel with the latter. Light reflected from the mirror 28 passes through a focusing lens 29 and is image-formed on the photodetecting surface of a solid-state imaging device 30.

Likewise, a mirror 31 is somewhat spaced from the reflection surface of the mirror 26 so as to be parallel with the latter. Light reflected from the mirror 31 passes through a focusing lens 32 and is image-formed on the photodetecting surface of a solid-state imaging device 33.

An electric control system of the digital camera 10 is equipped with a central control unit (CPU) 40 for controlling the entire digital camera 10 in a unified manner, a manipulation unit 41 (including the shutter release button 14) for receiving a manipulation instruction from a user, an image processing unit 42, an encoder 44 for encoding, into display data, image data as processed by the image processing unit 42, a driver 46 for displaying the display data on a display unit 45, a main memory 47, a medium control unit 49 for performing a write/read control on a memory card 48, and a bus 50 which connects the above units to each other.

Analog signal processing units (AFEs) 34 and 35 and analog/digital (A/D) converters 36 and 37 are connected to the solid-state imaging devices 30 and 33, respectively. Image signals generated by the solid-state imaging devices 30 and 33 are converted by the A/D converters 36 and 37 into digital signals, which are input to the bus 50. The pair of AFEs 34 and 35 and the pair of A/D converters 36 and 37 may each be combined into a single unit and be used in a switched manner.

A device control unit 51 is connected to the CPU 40. According to instructions from the CPU 40, the device control unit 51 controls the photographic lens 12, the focal point adjustment lens, and the telescopic lens and also controls the parallax separation means 23, the solid-state imaging devices 30 and 33, the AFEs 34 and 35, and the A/D converters 36 and 37.

When a 3D image of a subject is taken with the digital camera 10 having the above configuration, the solid-state imaging device 30 takes an image that would be recognized when the left eye sees the subject and the solid-state imaging device 33 takes an image that would be recognized when the right eye sees the subject. This is because, as mentioned above, a subject image that is inverted in the left-right direction and the top-bottom direction is taken as a result of focusing of incident light coming from a subject field by the photographic lens 12.

Image data taken by the solid-state imaging device 30 is taken in by the main memory 47, subjected to known image processing such as offset correction, gamma correction, and RGB/YC conversion and compressed in JPEG format in the image processing unit 42, and stored in the memory card 48. Likewise, image data taken by the solid-state imaging device 33 is taken in by the main memory 47, subjected to the above known image processing and compressed in JPEG format in the image processing unit 42, and stored in the memory card 48.

The two image data are stored as a pair of (left and right) image data in, for example, MPO format which is a standard established by Camera & Imaging Products Association (CIPA).

When left and right images of a subject are taken by the solid-state imaging devices 30 and 33, the CPU 40 controls the parallax separation means 23 in the following manner via the device control unit 51.

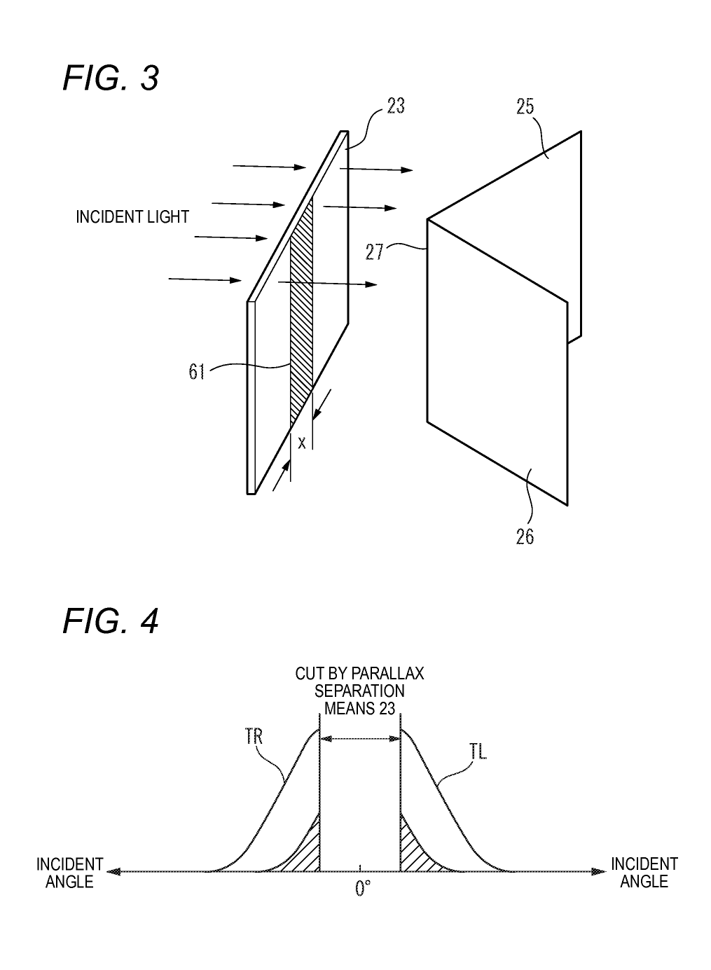

FIG. 3 illustrates the parallax separation means 23 and the light splitting mirror 24. In the embodiment, the parallax separation means 23 is a liquid crystal shutter and is erected perpendicularly to the optical axis of incident light. In liquid crystal shutters, an arbitrary region of the light incidence surface can be made a light non-transmissive region. In the embodiment, the parallax separation means 23 is constructed in such a manner that an light non-transmissive region 61 is formed so as to be opposed to (i.e., to cover) the entire length (from the top end to the bottom end) of the front joining edge 27 of the two mirrors 25 and 26.

The light non-transmissive region 61 is shaped like a rectangle that is long in the vertical direction, and its central vertical line is opposed to the front joining edge 27 of the mirrors 25 and 26. The width x of the light non-transmissive region 61 includes of the same, left and right widths that are bounded by the central vertical line. As such, the light non-transmissive region 61 completely interrupts that part of parallel light 22 (obtained by the relay lens 21 from incident light) which is in the region having the width x and extends fully in the vertical direction and which would otherwise go toward the front joining edge 27 of the mirrors 25 and 26 and its neighborhood.

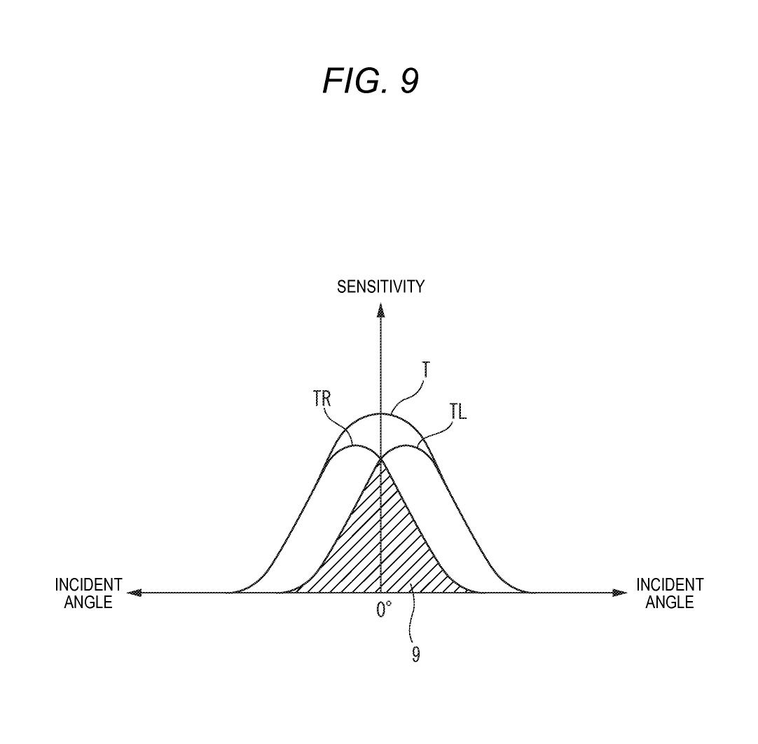

As a result, as shown in FIG. 4, a wide portion around the incident angle 0° of the sensitivity distributions TL and TR described above with reference to FIG. 9 is cut away, whereby the parallax between images taken by the solid-state imaging devices 30 and 33 can be increased.

In this manner, the parallax separation means 23 prevents light whose incident angle is around 0° (i.e., light that would otherwise enter the region that is centered by the front joining edge 27 of the mirrors 25 and 26 and has the width x) from shining on the solid-state imaging devices 30 and 33. As a result, image data that enables good stereoscopic vision can be obtained when a left-eye image and a right-eye image are taken by the right and left solid-state imaging devices 30 and 33 and reproduced.

The width x of the light non-transmissive region 61 may be a fixed value. However, it is preferable to variably control the width x. For example, the width x is decreased for a dark scene to prevent generation of an unduly dark image. The width x is increased for a bright scene.

Where the photographic lens 12 has a short focal length as in a case that it is a wide-angle lens, it is difficult to attain satisfactory separation for a parallax. Therefore, in this case, the width x of the light non-transmissive region 61 is set large to facilitate separation for a parallax. Conversely, the width x is set small in the case where the focal length is long as in the case of a telescopic lens.

Furthermore, the width x of the light non-transmissive region 61 may be controlled variably taking the f-number into consideration. The f-number is in many cases set small (wide aperture) for dark scenes and large (narrow aperture) for bright scenes. The width x of the light non-transmissive region 61 is set accordingly; that is, when the f-number is large, the width x is set large to increase the separation for a parallax because the target scene is bright and hence no sensitivity reduction is caused.

In the embodiment of FIGS. 2 and 3, the parallax separation means 23 is disposed immediately before the light splitting mirror 24 (mirrors 25 and 26) to shield the light splitting boundary line and its neighborhood of the light splitting mirror 24. However, the parallax separation means 23 need not always be disposed immediately before the light splitting mirror 24. A stop is also disposed close to the focal point of the photographic lens 12 which focuses incident light and, for example, the parallax separation means 23 may be disposed adjacent to this stop. This also makes it possible to divide incident light into two equal parts with a liquid crystal shutter that is small in area.

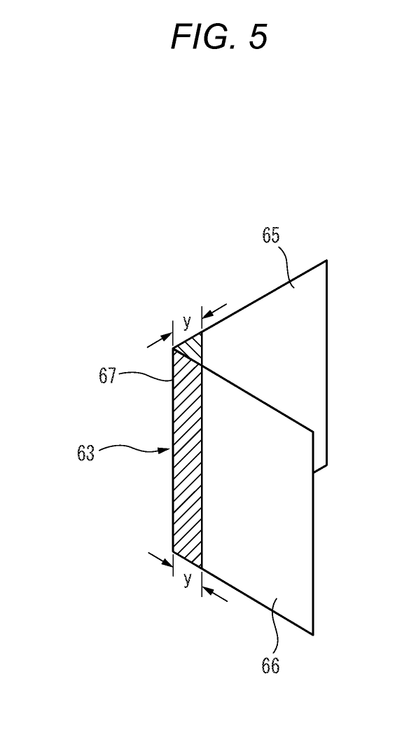

FIG. 5 is a perspective view of a parallax separation means and a light splitting means used in another embodiment that are integrated together. In this embodiment, electrochromic mirrors 65 and 66 whose reflectance can be controlled electrically and partially are used in place of the respective mirrors 25 and 26 shown in FIG. 3. The mirrors 65 and 66 are disposed in such a manner that their front edges are in contact with each other, they form a right angle, and a front joining edge 67 extends perpendicularly to the optical axis of incident light.

The reflectance of a tip portion including the joining edge 67 and having a width y of each of the mirrors 65 and 66 is changed to, preferably, 0% (the reflectance of the other portion is 100%). The portions whose reflectance is changed to 0% serve as a parallax separation means 63 of this embodiment. It is preferable that a measure be taken to enable variable control of the width y. This embodiment provides the same effect as is obtained by interrupting that part of incident light which is in the region having the prescribed width and extending along the left/right light splitting line (joining edge 67), whereby a wide portion around the incident angle 0° of left and right sensitivity distributions TL and TR is cut away in the same manner as described with reference to FIG. 4.

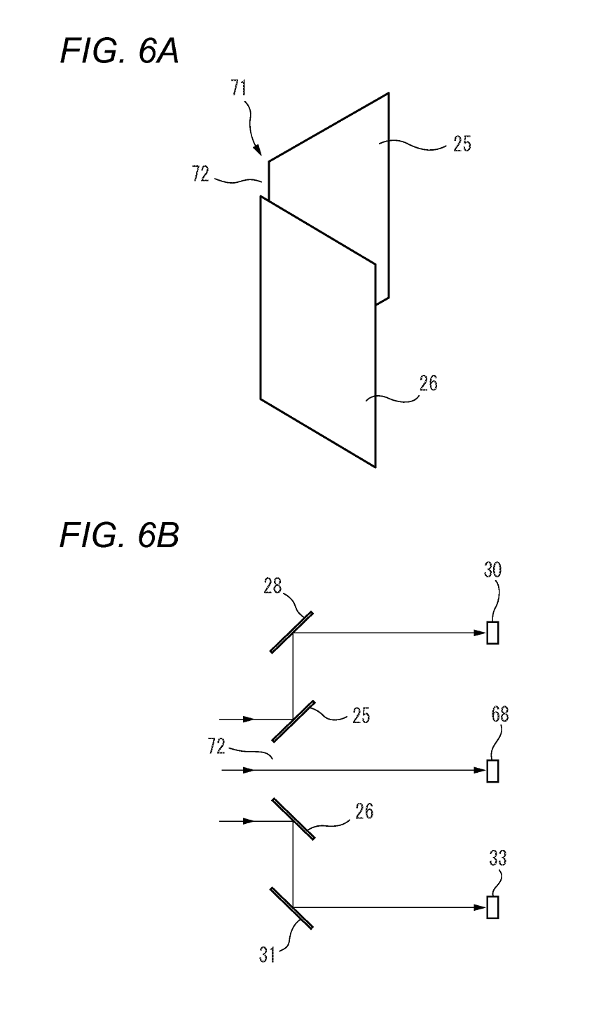

FIG. 6A is a perspective view of a parallax separation means and a light splitting means used in still another embodiment that are integrated together. This embodiment is different from the embodiment of FIG. 3 in that the mirrors 25 and 26 are shifted in the horizontal direction. Whereas in the embodiment of FIG. 3 the front edges of the mirrors 25 and 26 are in close contact with each other, in this embodiment a gap 72 is formed between them. The gap 72 serves as a parallax separation means. A measure is taken to variably control the width of the gap 72.

This structure makes it possible to prevent that part of incident light which is in the region extending along the imaginary left/right light splitting line from shining on the right and left solid-state imaging devices 30 and 33, whereby left-right separation for a parallax is attained satisfactorily in the same manner as described above with reference to FIG. 4. A third solid-state imaging device 68 for receiving light passing through the gap 72 may be provided as shown in FIG. 6B, in which case the solid-state imaging device 68 can take a two-dimensional image of a subject.

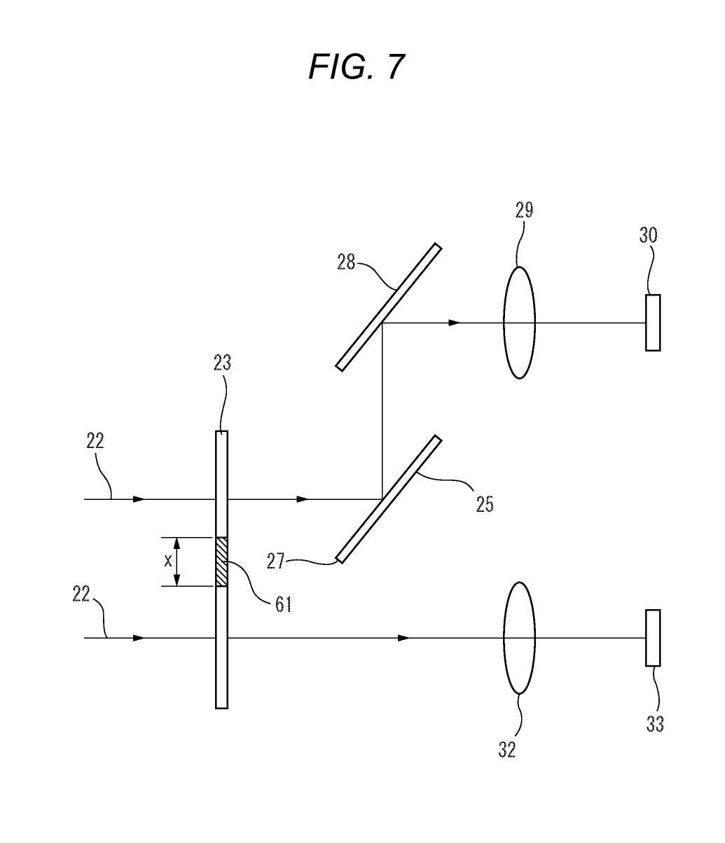

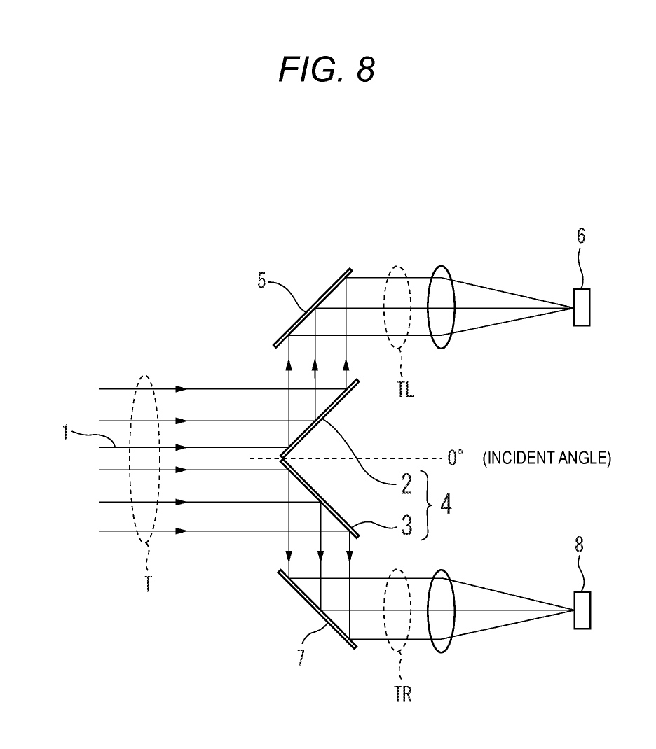

FIG. 7 shows a light splitting mirror used in a further embodiment of the invention. Although in the embodiment of FIG. 3 the mirrors 25 and 26 are disposed in such a manner that their front edges are in contact with each other and they form a right angle, the invention is not limited to such a case. In the embodiment of FIG. 7, the mirror 25 is not used and a right half of parallel light 22 is reflected by the mirror 25 and then by a mirror 28, focused by the focusing lens 29, and image-formed on the solid-state imaging device 30. A left half of the parallel light 22 is caused to go straight, focused by the focusing lens 32, and image-formed on the solid-state imaging device 33.

The front edge 27 of the mirror 25 serves as a boundary line for left-right separation for a parallax, that part of incident light which would otherwise enter the region including the boundary line and having the prescribed width x is interrupted by the parallax separation means 23. This embodiment makes it possible to decrease the width of the digital camera 10 because of the omission of the reflection optical path of the mirror 26.

Although in the above embodiments incident light is split into two parts (left and right parts) by a mirror(s), the optical member for splitting incident light into two parts (left and right parts) is not limited to a mirror(s) and may be any of other optical members such as a prism. Furthermore, although in the above embodiments light beams reflected from the mirrors 28 and 31 are focused and shine on the solid-state imaging devices 30 and 33, another configuration is possible in which the mirrors 25 and 26 are omitted and light beams reflected from the mirrors 28 and 31 are focused and shine on the solid-state imaging devices 30 and 33.

As described above, a 3D image taking apparatus of the embodiment(s) is characterized by comprising: a monocular photographic lens; a first and second solid-state imaging devices that receive one part and another part of incident light coming from a subject via the photographic lens in parallel; a light splitting member that splits the incident light into the one part and the other part of the incident light using a boundary region that extends perpendicularly to an optical axis, and causes the one part and the other part of the incident light to enter the first and second solid-state imaging devices, respectively; a parallax separation member that prevents a part of the incident light entering the boundary region from entering the first and second solid-state imaging devices; and an image processing unit that generates 3D image data of the subject by performing image processing on respective output signals of the first and second solid-state imaging devices.

And, the 3D image taking apparatus of the embodiment(s) is characterized by, further comprising: a control unit that controls a width of the boundary region.

And, the 3D image taking apparatus of the embodiment(s) is characterized in that, the control unit controls the width of the boundary region according to a shooting condition.

And, the 3D image taking apparatus of the embodiment(s) is characterized in that, the control unit increases the width of the boundary region as an f-number decreases, a shooting scene becomes brighter, or the focal length of the photographic lens decreases, and the control unit decreases the width of the boundary region as the f-number increases, the shooting scene becomes darker, or the focal length of the photographic lens increases.

And, the 3D image taking apparatus of the embodiment(s) is characterized in that, the parallax separation member is configured by a liquid crystal shutter disposed before the light splitting member, and cuts that part of the incident light entering the boundary region by a vertical-strip-shaped light non-transmissive region which is located at a center of the liquid crystal shutter.

And, the 3D image taking apparatus of the embodiment(s) is characterized in that, the light splitting member and the parallax separation member are integrally formed, the light splitting member is configured by disposing two mirrors in such a manner that they form a right angle and their front edges are in contact with each other, and the parallax separation member is configured by variably control a reflectance of a portion, including the front edge and having a prescribed width, of each of the two mirrors.

And, the 3D image taking apparatus of the embodiment(s) is characterized in that, the light splitting member and the parallax separation member are integrally formed, the light splitting member is configured by two mirrors which form a right angle, and the parallax separation member is configured by a gap between the two mirrors.

And, the 3D image taking apparatus of the embodiment(s) is characterized by, further comprising: a third solid-state imaging device that receives a part of the incident light passing through the gap between the two mirrors.

According to the above-described embodiments, since that part of incident light which would otherwise enter the region including the boundary line for separation for a parallax and having the prescribed width is cut, separation for a parallax can be attained satisfactorily and 3D image data that enable stereoscopic vision can be obtained though the apparatus is of the monocular type.

### INDUSTRIAL APPLICABILITY

The invention is useful when applied to low-cost 3D image taking apparatus because left/right separation for a parallax can be attained satisfactorily even though the monocular configuration is employed.

Although the invention has been described in detail by referring to the particular embodiments, it is apparent to those skilled in the art that various changes and modifications are possible without departing from the spirit and scope of the invention.

The present application is based on Japanese Patent Application No. 2011-45544 filed on Mar. 2, 2011, the disclosure of which is incorporated herein by reference.

### REFERENCE SIGNS LIST

10: Digital camera (3D image taking apparatus)

11: Rectangular body

12: Photographic lens

13: Lens barrel

21: Relay lens

23, 63: Parallax separation means

24: Light splitting mirror

25, 26: Reflection mirror

27, 67: Front joining edge (boundary for separation for a parallax)

30, 33: Solid-state imaging device

40: CPU

42: Image processing unit

61: Light non-transmissive region

x: Width of light non-transmissive region

1. A 3D image taking apparatus comprising:
a monocular photographic lens;
a first and second solid-state imaging devices that receive one part and another part of incident light coming from a subject via the photographic lens in parallel;
a light splitting member that splits the incident light into the one part and the other part of the incident light using a boundary region that extends perpendicularly to an optical axis, and causes the one part and the other part of the incident light to enter the first and second solid-state imaging devices, respectively;
a parallax separation member that prevents a part of the incident light entering the boundary region from entering the first and second solid-state imaging devices; and
an image processing unit that generates 3D image data of the subject by performing image processing on respective output signals of the first and second solid-state imaging devices.

2. The 3D image taking apparatus according to claim 1, further comprising:
a control unit that controls a width of the boundary region.

3. The 3D image taking apparatus according to claim 2, wherein
the control unit controls the width of the boundary region according to a shooting condition.

4. The 3D image taking apparatus according to claim 3, wherein
the control unit increases the width of the boundary region as an f-number decreases, a shooting scene becomes brighter, or the focal length of the photographic lens decreases, and
the control unit decreases the width of the boundary region as the f-number increases, the shooting scene becomes darker, or the focal length of the photographic lens increases.

5. The 3D image taking apparatus according to claim 1, wherein
the parallax separation member is configured by a liquid crystal shutter disposed before the light splitting member, and cuts that part of the incident light entering the boundary region by a vertical-strip-shaped light non-transmissive region which is located at a center of the liquid crystal shutter.

6. The 3D image taking apparatus according to claim 1, wherein
the light splitting member and the parallax separation member are integrally formed,
the light splitting member is configured by disposing two mirrors in such a manner that they form a right angle and their front edges are in contact with each other, and
the parallax separation member is configured by variably control a reflectance of a portion, including the front edge and having a prescribed width, of each of the two mirrors.

7. The 3D image taking apparatus according to claim 1, wherein
the light splitting member and the parallax separation member are integrally formed,
the light splitting member is configured by two mirrors which form a right angle, and the parallax separation member is configured by a gap between the two mirrors.

8. The 3D image taking apparatus according to claim 7, further comprising:
a third solid-state imaging device that receives a part of the incident light passing through the gap between the two mirrors.
